(19) United States
(12) Patent Application Publication
(10) Pub. No.: US 2025/0322302 A1
(43) Pub. Date: Oct. 16, 2025

(54) INFORMATION PROCESSING APPARATUS, INFORMATION PROCESSING METHOD, AND PROGRAM

(71) Applicant: NEC Corporation, Minato-ku, Tokyo (JP)

(72) Inventors: Yoichi SASAKI, Tokyo (JP); Yuzuru OKAJIMA, Tokyo (JP)

(73) Assignee: NEC Corporation, Minato-ku, Tokyo (JP)

(21) Appl. No.: 18/866,176

(22) PCT Filed: Jun. 10, 2022
(86) PCT No.: PCT/JP2022/023497

§ 371 Date: Nov. 15, 2024

(51) Int. Cl. G06N 20/00

(52) U.S. Cl. CPC G06N 20/00

(57) ABSTRACT

An information processing apparatus 100 of the present invention includes: an explanation generating unit 121 that generates explanatory data explaining a prediction value output by a machine learning model as a response to an input of training data; and a parameter calculating unit 122 that calculates a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

### TECHNICAL FIELD

The present disclosure relates to an information processing apparatus, an information processing method, and a program.

### BACKGROUND ART

In the field of machine learning, explainability of a machine learning model is important for humans to determine whether predictions by the machine learning model are trustable. Explanations of a machine learning model are roughly classified into two types, namely, global explanations (global explanations) and local explanations (local explanations). Global explanations explain the overall behavior of a machine learning model. Local explanations explain the grounds for predictions output for individual samples.

Here, Non-Patent Literature 1 discloses a technology in which, when a certain machine learning model is given, a simple model that locally approximates a prediction by the model about a similar sample near a sample is generated, and the simple model is output as a local explanation related to the prediction of the sample.

### CITATION LIST

### Non-Patent Literature

Non-Patent Literature 1: M. T. Ribeiro, S. Singh, and C. Guestrin, ““why should I trust you?”: Explaining the predictions of any classifier,” in Proceedings of the 22nd ACM SIGKDD International Conference on Knowledge Discovery and Data Mining, 2016, pp. 1135-1144.

### SUMMARY OF INVENTION

### Technical Problem

There is a problem with the technology disclosed in Non-Patent Literature 1 that an explanation output for each sample does not match an explanation expected by a human. This is because machine learning models are trained independently of what humans expect, and accordingly do not necessarily make predictions as the humans expect. However, even if a machine learning model outputs correct predictions, humans cannot trustingly use the machine learning model unless explanations expected by the humans are output.

The problem mentioned above becomes noticeable particularly when a machine learning model has been retrained. In a case where a machine learning model has been retrained by adding training samples, a human expects that the same explanation is output for the same prediction about the same sample, but there is a fear that, in the technology described in Non-Patent Literature 1, different explanations are output before and after retraining. As a result, humans cannot trustingly use a model that outputs different explanations every time the model is retrained.

Therefore, an object of the present disclosure is to provide an information processing apparatus that can solve the problem mentioned above that explanations of prediction values output by a machine learning model are different for each sample.

### Solution to Problem

An information processing apparatus which is an aspect of the present disclosure includes:
an explanation generating unit that generates explanatory data explaining a prediction value output by a machine learning model as a response to an input of training data; and
a parameter calculating unit that calculates a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

In addition, an information processing method which is an aspect of the present disclosure includes:
generating explanatory data explaining a prediction value output by a machine learning model as a response to an input of training data; and
calculating a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

In addition, a program which is an aspect of the present disclosure causes a computer to execute processes of:
generating explanatory data explaining a prediction value output by a machine learning model as a response to an input of training data; and
calculating a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

### Advantageous Effects of Invention

By being configured in the manners above, the present disclosure can generate a highly reliable machine learning model that can reduce situations where explanations of prediction values output by the machine learning model are different for each sample.

### BRIEF DESCRIPTION OF DRAWINGS

FIG. 1 is a figure for explaining a summary of the present disclosure.

FIG. 2 is a figure for explaining a summary of a first example embodiment of the present disclosure.

FIG. 3 is a block diagram depicting the configuration of an information processing apparatus in the first example embodiment of the present disclosure.

FIG. 4 is a flowchart depicting an operation performed by the information processing apparatus disclosed in FIG. 3.

FIG. 5 is a flowchart depicting an operation performed by the information processing apparatus disclosed in FIG. 3.

FIG. 6 is a flowchart depicting an operation performed by the information processing apparatus disclosed in FIG. 3.

FIG. 7 is a figure depicting a state of a process performed by the information processing apparatus disclosed in FIG. 3.

FIG. 8 is a figure depicting a state of a process performed by the information processing apparatus disclosed in FIG. 3.

FIG. 9 is a figure depicting a state of a process performed by the information processing apparatus disclosed in FIG. 3.

FIG. 10 is a figure depicting a state of a process performed by the information processing apparatus in a second example embodiment of the present disclosure.

FIG. 11 is a figure depicting a state of a process performed by the information processing apparatus in the second example embodiment of the present disclosure.

FIG. 12 is a block diagram depicting the hardware configuration of an information processing apparatus in a third example embodiment of the present disclosure.

FIG. 13 is a block diagram depicting the configuration of the information processing apparatus in the third example embodiment of the present disclosure.

### DESCRIPTION OF EMBODIMENTS

### First Example Embodiment

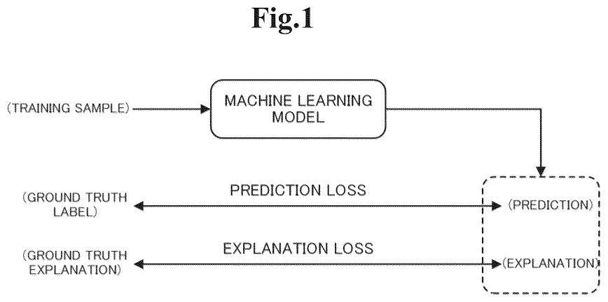

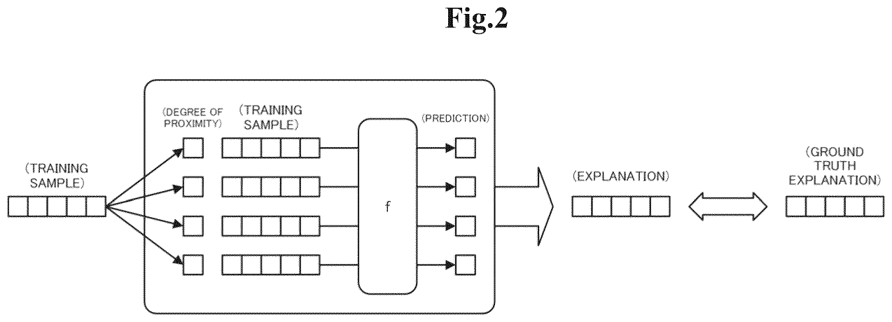

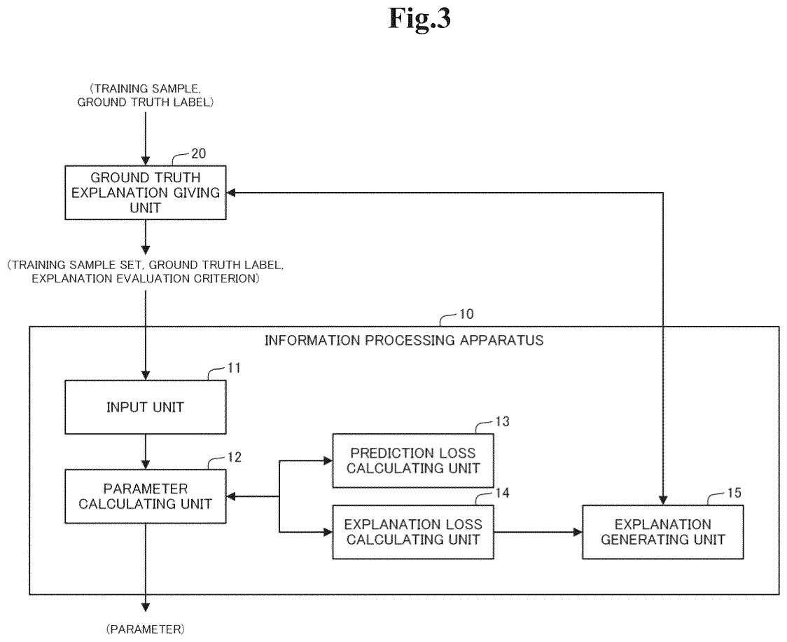

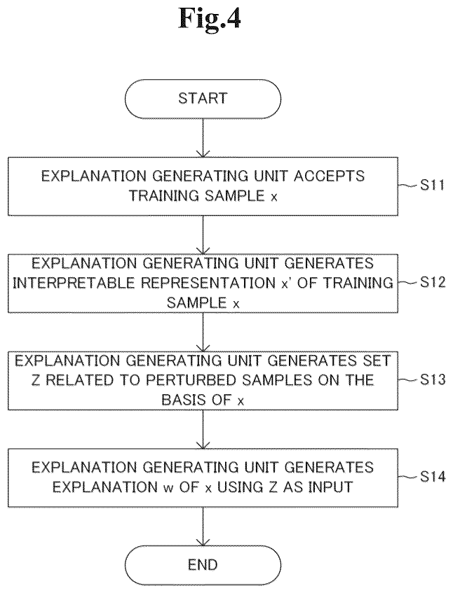

A first example embodiment of the present disclosure is explained with reference to FIG. 1 to FIG. 9. FIG. 1 to FIG. 2 are figures for explaining a summary of the present disclosure. FIG. 3 is a figure for explaining the configuration of an information processing apparatus, and FIG. 4 to FIG. 9 are figures for explaining processing operations performed by the information processing apparatus.

### Summary

First, a summary of the present disclosure is explained with reference to FIG. 1. As depicted in FIG. 1, the information processing apparatus in the present disclosure performs learning of a machine learning model using training samples, and updates parameters of the machine learning model. At this time, predictions and explanations of the predictions are output from the machine learning model to which the training samples have been input. In a situation like this, the information processing apparatus in the present disclosure performs learning such that the parameters of the machine learning model are updated so as to reduce a prediction loss representing the difference between a prediction output from the machine learning model and a preset ground truth label, and to reduce an explanation loss representing the difference between an explanation output from the machine learning model and a preset ground truth explanation. Note that the explanation loss may represent the degree of unsatisfaction of a preset criterion by an explanation output from the machine learning model.

Next, a summary of the first example embodiment is explained with reference to FIG. 2. As depicted in FIG. 2, in the first example embodiment, perturbed samples are randomly generated for training samples, and predictions by a model f about the perturbed samples are given. A simple model g that predicts inputs/outputs is trained using, as weights, the degrees of proximity between the training samples and the perturbed samples, and the weights are output as explanations. Using, as the explanation loss, the difference between the output explanations and preset explanations, similarly to what has been mentioned above, parameters of the model f are updated so as to reduce the prediction loss and the explanation loss. At this time, in a case where the simple model g is a linear model, explanations can be written as a function of the differentiable model f. Because of this, the gradient of the explanation loss related to the parameters of the model f can be calculated, and the parameters can be updated to reduce the explanation loss using the gradient. Note that the explanation loss may represent the degree of unsatisfaction of a preset criterion by an explanation output from the machine learning model.

### Details of First Example Embodiment

Next, details of the first example embodiment are explained. In the first example embodiment, regarding any machine learning model whose parameters can be updated using the gradient, the parameters of the machine learning model are updated such that expected explanations are output as explanations for respective samples. The present example embodiment can be applied to any machine learning model whose parameters can be updated using the gradient. Explanations in the present example embodiment are weights of a linear model that locally approximates an operation performed by the machine learning model. Note that terms and symbols used for explanation of the present example embodiment comply with Non-Patent Literature 1.

First, the basic concept used in the explanation of the present example embodiment is explained. It is assumed that a machine learning model trained in the first example embodiment is f. f may be any machine learning model as long as it is a machine learning model whose parameters can be updated using the gradient of an objective function. As such a model f, for example, a neural network or gradient boosting can be used. Furthermore, parameters that decide the behavior of the model f are represented by a vector θ. For example, in a case where the model f is a neural network, θ is a vector including weights of the neural network. In a case where the model f is gradient boosting, θ is the number of weak learners or parameters of the weak learners. Outputs of the model f are decided depending on values of θ.

In supervised machine learning, typically, a training sample set, and a ground truth label associated with each training sample included in the training sample set are input. Then, parameters are updated to reduce the difference between a prediction output by the model f when each training sample is input to the model f and a ground truth label associated with the training sample. The difference between the prediction and the ground truth label is called the prediction loss.

However, there is a problem that simply updating parameters so as to reduce the prediction loss does not enable the model f to output an explanation of a prediction which is an explanation as expected by a human. In view of this, the present disclosure aims not only for reducing the prediction loss, but takes a loss related to an explanation into consideration. Specifically, in the present disclosure, an explanation evaluation criterion which is a criterion for evaluating the appropriateness of an explanation is accepted as an input. The explanation loss which is the degree of unsatisfaction of the explanation evaluation criterion by an explanation generated for a prediction output by the model f as a response to each training sample is considered. The parameters θ of the model f are updated so as to reduce not only the prediction loss, but also the explanation loss. In particular, it is effective to update the parameters so as to reduce a weighted sum of the prediction loss and the explanation loss. Thereby, it is possible to achieve a balance between the prediction loss and the explanation loss.

It is possible that, for example, the matching degree with ground truth explanations is used as the explanation evaluation criterion. In this case, this results in updating parameters so as to enable a model to output explanations matching ground truth explanations as much as possible. As ground truth explanations, for example, explanations having already been presented to a human in the past can be used. Such a manner of use is particularly useful in a case where parameters of a model being operationally used are updated. There is a case where, although a model trained using a training sample set has been operationally used, several training samples have been additionally obtained later, and accordingly it is desired to retrain the model by adding the additionally obtained several training samples to the training sample set. At this time, there is a need that it is desired to not change, as much as possible, predictions and explanations for the same samples before and after retraining. If a different explanation is output, it is difficult for a human to understand why the explanation is different from a past explanation. In such a case, the explanation that has been presented to the human in the past can be used as a ground truth explanation. In this case, the present invention can update parameters such that predictions are not so different, and moreover explanations do not change significantly, taking into consideration a balance between the prediction loss and the explanation loss.

Next, the specific configuration of and operations performed in the first example embodiment are explained with reference to FIG. 3 to FIG. 9. As depicted in FIG. 3, the information processing system in the first example embodiment includes an information processing apparatus 10 that performs machine learning. Note that, in FIG. 3, a ground truth explanation giving unit 20 that is configured using an information processing apparatus that inputs data to be used for machine learning is mounted, and this is mentioned later; however, the ground truth explanation giving unit 20 is not provided necessarily.

The information processing apparatus 10 that performs machine learning is configured using one or more information processing apparatuses including an arithmetic apparatus and a storage apparatus. As depicted in FIG. 3, the information processing apparatus 10 includes an input unit 11, a parameter calculating unit, a prediction loss calculating unit 13, an explanation loss calculating unit 14, and an explanation generating unit 15. Respective functions of the input unit 11, the parameter calculating unit 12, the prediction loss calculating unit 13, the explanation loss calculating unit 14, and the explanation generating unit 15 can be realized by the arithmetic apparatus executing programs that are stored on the storage apparatus, and are for realizing the respective functions. Hereinafter, operations performed by functions that the respective configurations have are explained.

Before an overall operation performed in the first example embodiment is explained, an operation performed by the explanation generating unit 15 is explained with reference to a flowchart in FIG. 4.

### (Step S11)

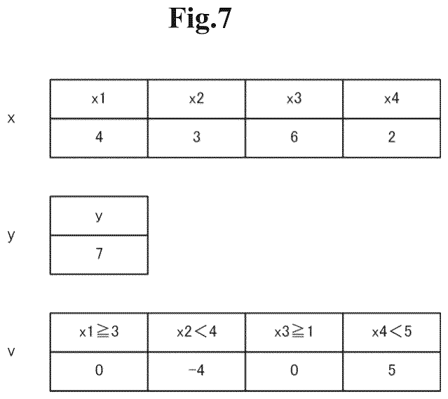

The explanation generating unit 15 accepts a training sample x (training data) as an input. The training sample x is a real number vector with a length d representing a sample to be input to the model f. x may represent table data or may represent an image or a text. FIG. 7 depicts an example of the training sample x.

### (Step S12)

The explanation generating unit 15 generates an interpretable representation x′ of the training sample x. The interpretable representation x′ is a binary vector with a length d′. x′ represents the training sample x in such a manner that a human can easily understand whether or not there is a feature. x′ can be in any of various forms like those explained in 3.1 in Non-Patent Literature 1. For example, in a case where the training sample x is a text, a binary vector representing whether or not there is a word can be used as x′. Any method can be used as a method of generating an interpretable representation as long as it is a method that can transform the training sample x into a binary vector, and allows humans to interpret a result thereof. If the training sample x is a binary vector already, x may be used as x′ as it is.

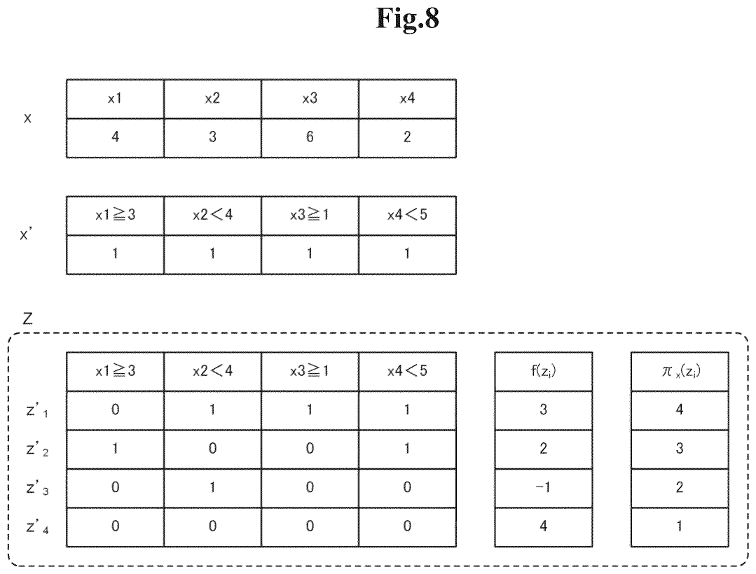

As an example here, a method that can be used in a case where the training sample x is a vector of consecutive values (hereinafter, called a threshold method) is explained. Regarding each of d elements included in x, two conditions are generated using its median as a threshold for division. For example, in a case where the median of the first element x1 of x is 3, two conditions, “x1≤3” and “x1<3,” are generated. This is performed repeatedly also for other elements, and d*2 conditions are generated. Last, only conditions satisfied by x are extracted, and are used as feature values included in x′. Note that the value of each feature value is 1 in a case where the condition is satisfied, and is 0 otherwise. An example of x′ generated by the threshold method is depicted in FIG. 8. As depicted in this figure, in a case where x′ is created by this method, all elements of x′ are inevitably 1 since only conditions satisfied by x are extracted. In the threshold method, quartiles may be used instead of a median for division into four conditions. In implementation (https://github.com/marcotcr/lime) disclosed by the authors of Non-Patent Literature 1, a threshold method using quartiles is implemented.

### (Step S13)

At step S13, the explanation generating unit 15 generates a set Z of perturbed samples (perturbed samples) on the basis of x′. The perturbed samples are samples that are generated artificially, and are used as training samples for constructing a second machine learning model approximating a local prediction around x by f. A method of generating the set Z is based on an algorithm depicted in 3.3 or Algorithm 1 of Non-Patent Literature 1.

Parameters for generating the set Z are defined as follows. It is assumed that the number of perturbed samples to be generated is N. It is assumed that a function for measuring the degree of proximity to x is πₓ. πₓ(z) is any function that gives a value that increases as a vector z with the length d gets closer to x, and gives a value that decreases as the vector z gets farther from x. For example, a cosine similarity of the vector can be used.

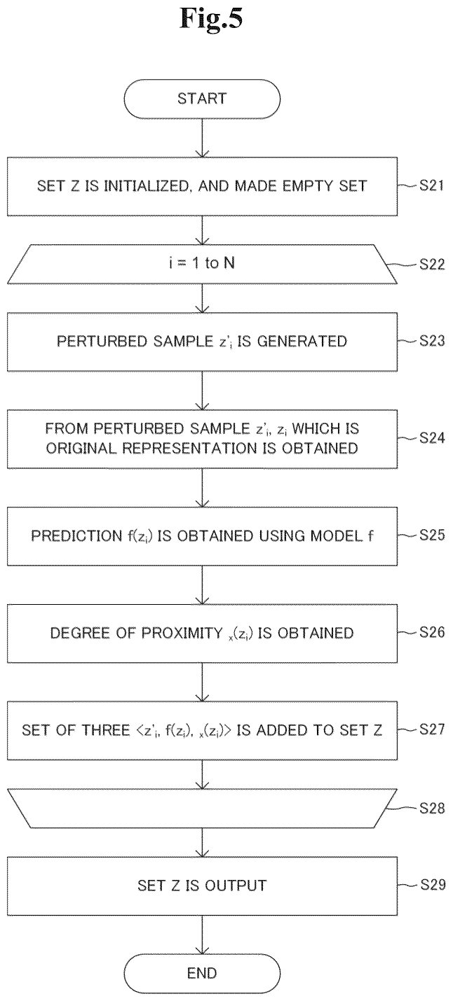

Here, a method of generating the set Z performed at step S13 in FIG. 4 is depicted in a flowchart in FIG. 5. First, the set Z is initialized, and made an empty set (Step S21). The following is executed while changing a variable i from 1 to N (Step S22).

The i-th perturbed sample z′ᵢ is generated (Step S23). The perturbed sample z′ᵢ is a binary vector with the length d′ like x′. The perturbed sample may be generated by any method as long as a binary vector with the length d′ is obtained. For example, the perturbed sample can be obtained by uniformly randomly generating a binary vector with the length d′. FIG. 8 depicts an example of the generated perturbed sample z′ᵢ. In contrast to x′ whose value is always 1, the perturbed sample z′ᵢ assumes a value which is 1 or 0.

From the perturbed sample z′ᵢ, zᵢ which is a representation in a space before a transformation is obtained (Step S24). zᵢ is a vector with the same length d as x. For example, in the case of an image classification task, a corresponding image is obtained from a binary vector. In the case of the threshold method described above, for example, zᵢ can be obtained from the perturbed sample z′ᵢ by the following method. The average and standard deviation of the d elements in the training sample set are calculated. Then, values are sampled from d normal distributions having these average and standard deviation as parameters, and samples that satisfy the same conditions as z′ᵢ are treated as zᵢ. For example, in the case of the example depicted in FIG. 8, because z′₂ satisfies four conditions, “x1≥3,” “x2≥4,” “x3<1,” and “x4<5,” values that satisfy these conditions are randomly generated, and treated as z₂.

Next, a prediction f(zᵢ) is obtained using the model f (Step S25). By inputting zᵢ to f, the prediction f(zᵢ) by f is obtained. Next, a degree of proximity πₓ(zᵢ) is obtained (Step S26). A set of three <z′ᵢ, f(zᵢ), πₓ(zᵢ)> is added to the set Z (Step S27).

The processes described above are repeated N times (Step S28), and the set Z is output last (Step S29). These are processes performed at step S13.

### (Step S14)

Next, the explanation generating unit 15 generates an explanation w (vector w) of x using Z as an input. Specifically, an interpretable model g is trained using z′ᵢ as a training sample, f(zᵢ) as a ground truth label, and πₓ(zᵢ) as a weight on samples, and parameters of g obtained by the training is output as w.

A method of calculating the explanation w in a case where the interpretable model g is a linear model is explained. In a case where the interpretable model g is a linear model, the interpretable model g can be represented by the following Formula 1.

$$g ( z ) = {w}^{T} z \qquad [ Formula 1 ]$$

Note that a linear model from which an intercept is omitted is used for simplification of the explanation here, but a linear model taking into consideration an intercept can be formed simply by adding, to z, an element with which 1 is obtained always.

At this time, an N×d′ design matrix (design matrix) D is defined by the following Formula 2.

$$D = ( \begin{matrix}{z}_{11}^{′} & … & {z}_{1 {d}^{′}}^{′} \\ ⋮ & ⋱ & ⋮ \\ {z}_{N 1}^{′} & … & {z}_{{Nd}^{′}}^{′}\end{matrix} ) \qquad [ Formula 2 ]$$

Here, z′ᵢⱼ represents the j-th element of z′ᵢ.

In addition, a vector f_{z} with a length N representing predictions by the model f about N perturbed samples is defined by the following Formula 3.

$${f}_{z} = ( \begin{matrix}f ( {z}_{1} ) \\ ⋮ \\ f ( {z}_{N} )\end{matrix} ) \qquad [ Formula 3 ]$$

Furthermore, a sample weighting matrix Π is defined as an N×N diagonal matrix represented by the following Formula 4.

$$\prod = ( \begin{matrix}{π}_{x} ( {z}_{1}^{′} ) & ⋯ & 0 \\ ⋮ & ⋱ & ⋮ \\ 0 & ⋯ & {π}_{x} ( {z}_{N}^{′} )\end{matrix} ) \qquad [ Formula 4 ]$$

At this time, the explanation w is w that minimizes a loss function Lw represented by the following Formula 5.

$${L}_{w} = {‖ {\prod }^{\frac{1}{2}} ( {f}_{z} - Dw ) ‖}^{2} + λ {‖ w ‖}^{2} \qquad [ Formula 5 ]$$

In the first term in Formula 5, a squared error of the difference between a prediction f_{z} output by f and a prediction Dw output by g is given a degree of proximity as a weight. The second term is a normalization term. The coefficient X is any positive real number.

The explanation w that minimizes the loss described above can be calculated by the following Formula 6.

$$w = {( {Z}^{T} \prod Z + λ I )}^{- 1} {Z}^{T} \prod {f}_{z} \qquad [ Formula 6 ]$$

I is a d′×d′ identity matrix. Here, a matrix A is defined by the following Formula 7.

$$A = {( {Z}^{T} \prod Z + λ I )}^{- 1} {Z}^{T} \prod \qquad [ Formula 7 ]$$

At this time, the explanation w can be written like the following Formula 8 as a linear transform of the prediction f_{z}.

$$w = {Af}_{z} \qquad [ Formula 8 ]$$

Formula 8 described above is differentiable since it is a linear transform.

As mentioned above, the explanation w can be obtained in the form of a differentiable function of a prediction by the model f. Since the explanation is differentiable, as mentioned later, the gradient of explanation loss of the parameters θ of the model f can be calculated, and the parameters θ of the model f can be updated.

Here, differences from Non-Patent Literature 1 are mentioned. The explanation generation method performed by the explanation generating unit of the present example embodiment is basically similar to Algorithm1 of Non-Patent Literature 1. However, in Non-Patent Literature 1, a model that is difficult to differentiate, namely k-Lasso, is adopted as the model g for explanation. This is because parameters of the model f are never updated using differentiation since the final object is to generate an explanation in Non-Patent Literature 1.

On the other hand, in the present example embodiment, an object is to update parameters of f using a generated explanation. Because of this, by using not K-Lasso but a linear model as g, the explanation w is represented in the form of a differentiable function of a prediction by the model f. Thereby, it becomes possible to update parameters of f using the gradient.

Note that, whereas a linear model is used in the present example embodiment, another model may be used as long as the explanation w can be represented in the form of a differentiable function of a prediction by the model f. An operation performed by the explanation generating unit 15 has been explained thus far.

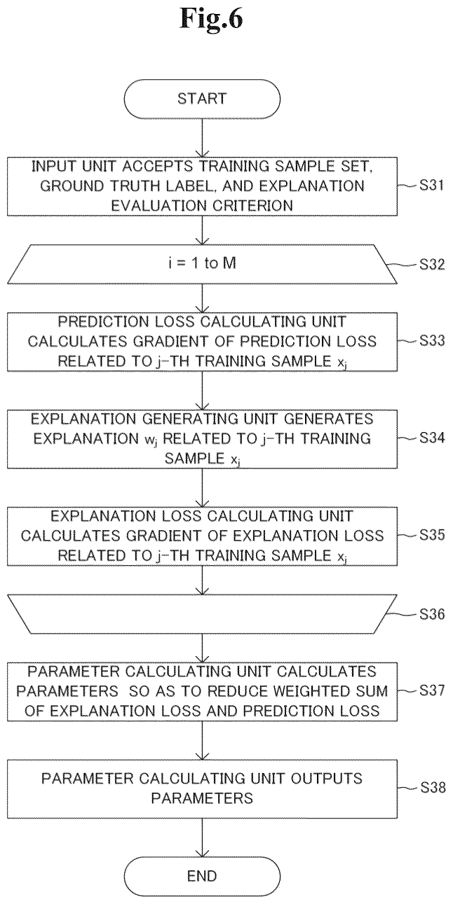

Next, an overall operation performed by the information processing apparatus 10 in the present example embodiment is explained with reference to FIG. 6.

First, a training sample set, a ground truth label, and an explanation evaluation criterion to be input to the input unit 11 are explained.

A training sample set X is a set of M training samples as represented by Formula 9. Each sample is a vector with the length d.

$$X = \{ {x}_{1} , … , {x}_{M} \} \qquad [ Formula 9 ]$$

A ground truth label y is a vector with a length M representing a label which is a target of prediction by the model f as represented by Formula 10.

$$y = ( \begin{matrix}{y}_{1} \\ ⋮ \\ {y}_{M}\end{matrix} ) \qquad [ Formula 10 ]$$

Elements of the ground truth label y are classes in the case of classification (classification), and are real numbers in the case of regression (regression). Hereinafter, for explanation, it is assumed that the ground truth label y includes real numbers supposing that the present invention is applied to regression. The present invention can be applied to classification and to regression.

Note that the explanation evaluation criterion is explained later.

Next, an objective function of the present example embodiment is explained. An objective function L is given in the form of a weighted sum of the prediction loss and the explanation loss as in the following Formula 11.

$$L = {\sum }_{j = 1}^{M} ( {P}_{i} + λ {E}_{j} ) \qquad [ Formula 11 ]$$

Here, Pⱼ is the prediction loss related to the j-th training sample, and is a value representing the degree of difference between a ground truth label and a prediction output by the model f for a training sample. Eⱼ is the explanation loss related to the j-th training sample, and is a value representing the degree of unsatisfaction of the explanation evaluation criterion by a generated explanation. λ is a coefficient for achieving a balance between the two losses.

In order to update parameters with regard to the objective function, it is sufficient if the gradient of Pⱼ and the gradient of Eⱼ can be calculated. In particular, an updating formula of gradient descent is the following Formula 12.

$${θ}^{( t + 1 )} = {θ}^{( t )} - η \frac{\partial L}{\partial {θ}^{( t )}} \qquad [ Formula 12 ]$$

It should be noted that θ^{(t)} is parameters of t-th updating, and η is a learning rate (learning rate). Here, because of Formula 13, the parameters can be updated if the gradient of Pⱼ and the gradient of Eⱼ related to θ can be known. In view of this, at and after step S32, the gradient of Pⱼ and the gradient of Eⱼ are calculated regarding j=1, . . . , M.

$$\frac{\partial L}{\partial θ} = {\sum }_{j = 1}^{M} ( \frac{\partial {P}_{j}}{\partial θ} + λ \frac{\partial {E}_{j}}{\partial θ} ) \qquad [ Formula 13 ]$$

### (Step S31)

The input unit 11 accepts a training sample set, a ground truth label, and an explanation evaluation criterion.

### (Step S32)

For j=1, . . . , M, the following is repeated.

### (Step S33)

The prediction loss calculating unit 13 calculates the gradient of the prediction loss related to the j-th training sample xⱼ. For example, a squared error like the one represented by the following Formula 14 can be used as the prediction loss in the case of regression.

$${P}_{j} = \frac{1}{2} {‖ {y}_{j} - f ( {x}_{j} ) ‖}^{2} \qquad [ Formula 14 ]$$

At this time, the gradient of the prediction loss related to f can be calculated as in the following Formula 15.

$$\frac{\partial {P}_{j}}{\partial f ( {x}_{j} )} = - ( {y}_{j} - f ( {x}_{j} ) ) \qquad [ Formula 15 ]$$

When the gradient of the prediction loss related to f is known, the gradient of the prediction loss related to θₖ can be calculated as in the following Formula 16. θₖ is the k-th element of θ.

$$\frac{\partial {P}_{j}}{\partial {θ}_{k}} = \frac{\partial {P}_{j}}{\partial f ( {x}_{j} )} \frac{\partial f ( {x}_{j} )}{\partial {θ}_{k}} \qquad [ Formula 16 ]$$

In the case of a neural network, a term represented by Formula 17 in Formula 16 can be calculated by error backpropagation.

$$\frac{\partial f ( {x}_{j} )}{\partial {θ}_{k}} \qquad [ Formula 17 ]$$

### (Step S34)

The explanation generating unit 15 generates an explanation wⱼ related to the j-th training sample xⱼ. The explanation wⱼ is generated by the method explained in the description above.

### (Step S35)

The explanation loss calculating unit 14 calculates the gradient of the explanation loss related to the j-th training sample xⱼ. Here, the explanation loss is defined on the basis of the explanation evaluation criterion. The explanation evaluation criterion is a criterion that an explanation of a prediction by a machine learning model with regard to a training sample should satisfy. The explanation evaluation criterion can be any criterion as long as it can evaluate a generated explanation. Typically, as the explanation evaluation criterion, a ground truth explanation which is an explanation itself that should be output as an explanation of a prediction with regard to a training sample can be used. It is assumed in the following that a ground truth explanation associated with the j-th training sample is vⱼ. vⱼ is a vector with the length d′.

For example, a squared error represented by the following Formula 18 can be used as the explanation loss Eⱼ. The explanation loss Eⱼ increases as the difference between the ground truth explanation vⱼ and the explanation wⱼ generated with regard to the j-th training sample increases.

$${E}_{j} = \frac{1}{2} {‖ ( {v}_{j} - {w}_{j} ) ‖}^{2} \qquad [ Formula 18 ]$$

In a case where g is a linear model, Eⱼ can be represented by Formula 19 using the matrix A defined regarding the explanation generating unit 15.

$${E}_{j} = \frac{1}{2} {‖ ( {v}_{j} - {Af}_{z}^{( j )} ) ‖}^{2} \qquad [ Formula 19 ]$$

Here, the term represented by Formula 20 in Formula 19 is a vector with the length N representing predictions by f related to N perturbed samples generated regarding the j-th training sample.

$${f}_{z}^{( j )} \qquad [ Formula 20 ]$$

The gradient of the explanation loss related to Formula 20 can be calculated as in the following Formula 21.

$$\frac{\partial {E}_{j}}{\partial {f}_{z}^{( j )}} = - ( {v}_{j} - A {f}_{z}^{( j )} ) {A}^{T} \qquad [ Formula 21 ]$$

The gradient of the prediction loss related to the k-th element θₖ of the parameter vector θ can be written as the inner product of vectors as in the following Formula 22 by the chain rule.

$$\frac{\partial {E}_{j}}{\partial {θ}_{k}} = \frac{\partial {E}_{i}}{\partial {f}_{z}^{( j )}} \frac{\partial {f}_{z}^{( j )}}{\partial {θ}_{k}} \qquad [ Formula 22 ]$$

Here, the term represented by Formula 23 in Formula 22 can be calculated in the manner mentioned above.

$$\frac{\partial {E}_{j}}{\partial {f}_{z}^{( j )}} \qquad [ Formula 23 ]$$

The term represented by Formula 24 in Formula 22 is represented by Formula 25 on the basis of the definition of Formula 20. Accordingly, it is sufficient if the gradient of f is calculated about N predictions with regard to the N perturbed samples. For example, this gradient can be calculated using error backpropagation in the case of a neural network.

$$\frac{\partial {f}_{z}^{( j )}}{\partial {θ}_{k}} \qquad [ Formula 24 ]$$

$$\frac{\partial {f}_{z}^{( j )}}{\partial {θ}_{k}} = ( \begin{matrix}\frac{\partial f ( {z}_{1} )}{\partial {θ}_{k}} \\ ⋮ \\ \frac{\partial f ( {z}_{N} )}{\partial {θ}_{k}}\end{matrix} ) \qquad [ Formula 25 ]$$

### (Step S36)

These are repeated for M samples, and the procedure proceeds to the next step.

### (Step S37)

Next, the parameter calculating unit 12 calculates the parameters θ using the gradient. In the case of a neural network, the parameters θ can be updated by gradient descent. Since the gradients of Pⱼ and Eⱼ related to the parameters θ have already been calculated as described above, it is sufficient if the parameters θ are updated by an updating formula of gradient descent using the gradients.

### (Step S38)

Thereafter, the updated parameters are output.

Note that the procedure from step S32 to S37 may be repeated multiple times. Thereby, the parameters are updated multiple times, and it is expected that loss decreases by a corresponding amount, thereby allowing the parameters to approach better parameters.

Next, still other possible variations of the first example embodiment are explained.

### (Case of Gradient Boosting)

A case where the model f is based on gradient boosting is explained. In gradient boosting, instead of using an updating formula of gradient descent, parameters are updated by adding a base learner (base learner) whose target value is pseudo-residuals (pseudo-residuals). In gradient boosting, parameters can be considered as being added every time updating is performed.

In typical gradient boosting, a pseudo-residual rⱼ which is the target value of the j-th training sample is calculated as in the following Formula 26.

$${r}_{j} = - \frac{\partial {P}_{j}}{\partial f} \qquad [ Formula 26 ]$$

Using Formula 27 as a training sample set, the base learner is trained and added.

$${\{ ( {x}_{j} , {r}_{j} ) \}}_{j = 1}^{M} \qquad [ Formula 27 ]$$

In a case where gradient boosting is applied to the present disclosure, N perturbed samples represented by the following Formula 28 are added further per one training sample to the training sample set to be used when the base learner is trained.

$${\{ ( {z}_{i} , {s}_{i} ) \}}_{i = 1}^{N} \qquad [ Formula 28 ]$$

It should be noted that a pseudo-residual sᵢ related to a perturbed sample is calculated as in the following Formula 29.

$${s}_{i} = - {λ ( \frac{\partial {E}_{j}}{\partial {f}_{z}^{( j )}} )}_{i} \qquad [ Formula 29 ]$$

That is, sᵢ is obtained by multiplying the i-th element in Formula 23 by (−λ).

By adding the thus-calculated base learner, parameters are updated such that not only the prediction loss but also the explanation loss decreases.

### (Example of Explanation Evaluation Criterion)

In the method explained in the description above, a ground truth explanation associated with each training sample is used as an explanation evaluation criterion. Note that a different one may be used as an explanation evaluation criterion. For example, an explanation evaluation criterion may be a set of suffixes representing elements of training samples that should be used for explanations. The following is an example of such a set. {2, 3, 5}

In a case where a set like the one described above is given as an explanation evaluation criterion, an explanation related to {x₂, x₃, x₅} is given a negative explanation loss. Then, parameters are updated so as to reduce the explanation loss. Thereby, an explanation to which {x₂, x₃, x₅} is related can be obtained with priority. For example, the explanation loss represented by the following Formula 30 can be used.

$${E}_{j} = - {\sum }_{l = 1}^{{d}^{′}} {1}_{i} {w}_{j , l}^{2} \qquad [ Formula 30 ]$$

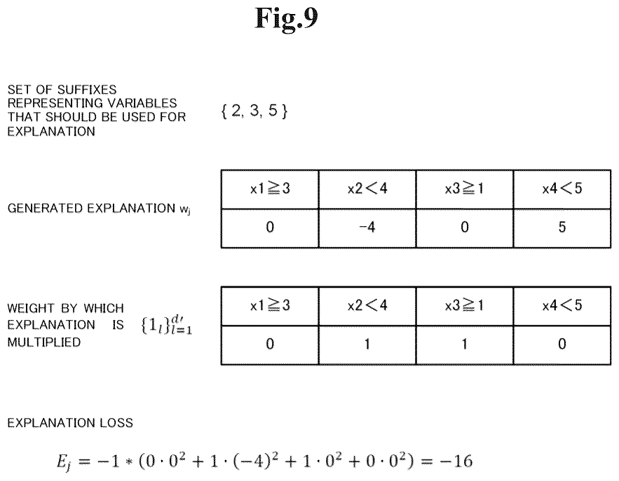

Here, w_{j,l} represents the l-th element of the explanation wⱼ generated with regard to the j-th training sample. It is assumed that 1ₗ is a variable that becomes 1 in a case where the l-th element of the explanation relates to a variable represented by the suffix set mentioned above, and becomes 0 otherwise. Examples of the thus-calculated explanation evaluation criterion and explanation loss are depicted in FIG. 9.

Here, as depicted in FIG. 3, there may be the ground truth explanation giving unit 20 before the input unit 11. The ground truth explanation giving unit 20 accepts a training sample set and ground truth labels associated with training samples. The ground truth explanation giving unit 20 associates the ground truth explanations with the training samples. The ground truth explanation giving unit 20 gives the input unit 11 the ground truth explanations as an explanation evaluation criterion along with the training sample set and the ground truth labels.

As the ground truth explanations, for example, explanations in a case where initial parameters θ before being updated are used can be used. An explanation in a case where a prediction is calculated using the initial parameters θ is generated for each training sample, this is handled as a ground truth explanation, and the degree of difference from the ground truth explanation is used as the explanation loss.

In addition, ground truth explanations need not be associated with all the training samples included in the training sample set. For example, ground truth explanations may be associated with only training samples whose explanations have already been presented to a human once, and ground truth explanations may not be associated with newly-added training samples. That is, ground truth explanations may be associated with only training samples that, when input to a machine learning model having already been trained, make the machine learning model output prediction values matching ground truth labels. Thereby, it is possible to retrain the model such that predictions with regard to recently-added training samples also are correct, while causing explanations having already been presented to a human once and new explanations to match as much as possible. That is, it is possible to cause the model to incorporate information included in new samples while maintaining the consistency with explanations presented in the past.

### Second Example Embodiment

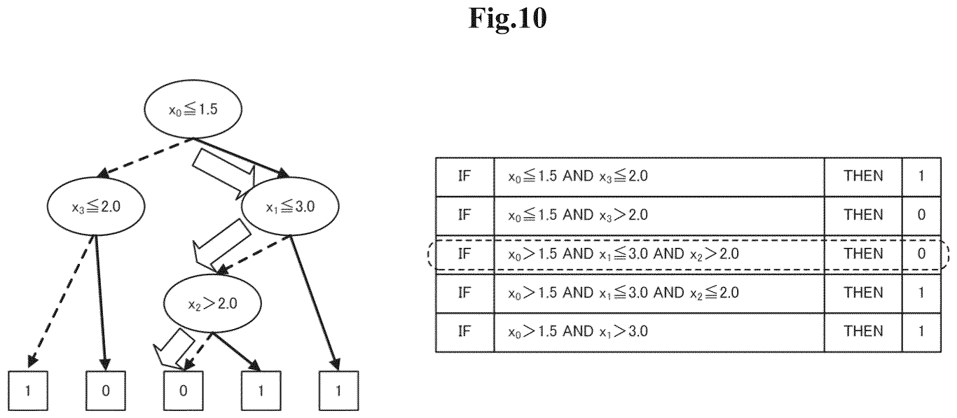

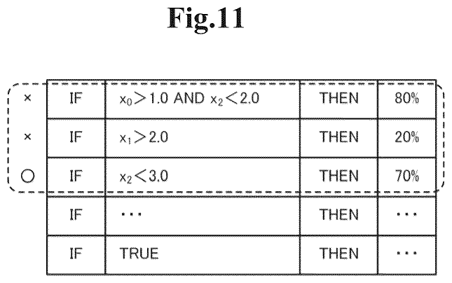

Next, a second example embodiment of the present disclosure is explained with reference to FIG. 10 to FIG. 11. FIG. 10 to FIG. 11 are figures for explaining processing operations in the second example embodiment.

A machine learning model which is treated as the target in the present example embodiment is the model f that performs prediction using a plurality of rules, and, for example, is a decision tree or a decision list. In this case, rules to which training data is relevant in the decision tree or the decision list are explanations of predictions. That is, in the present example embodiment, when prediction is performed as a response to an input of a training sample to the decision tree or the decision list, the explanation generating unit 15 mentioned above generates, as explanatory data, a decided rule that has been followed to produce a prediction value output by the decision tree or the decision list. In the present example embodiment, similarly to what has been mentioned above, the parameter calculating unit 12 mentioned above learns by calculating rules (parameters) of the decision tree or the decision list so as to reduce the prediction loss which is the difference between an output prediction value and a preset ground truth value, and to reduce the explanation loss which is the difference between explanatory data which is a decided rule and a preset ground truth rule.

Here, FIG. 10 depicts an example of the decision tree. As depicted in this figure, the decision tree has a root node which branches into a plurality of leaf nodes, and represents a plurality of rules, each of which is represented by a path from the root node to a leaf node. Among them, one leaf node that has been reached in the end gives a prediction value, but a path to the one leaf node that has given the prediction value after each node is followed from the root node in order about a given sample is a decision rule, and the decision rule is explanatory data. Because of this, in a case where a path like the one represented by thick arrows is a decision rule in a case where a training sample is given to the decision tree depicted in FIG. 10, the explanation generating unit 15 generates, as explanatory data, a decision rule “x₀>1.5 AND x₁≤3.0 AND x₂>2.0” surrounded by a dotted-line frame representing the decision rule.

In addition, FIG. 11 depicts an example of the decision list. As depicted in this figure, the decision list is a list of a plurality of rules that are arranged next to each other in order. When prediction is performed, rules are checked starting from the one on the top in order, and one or more rules satisfied by a given sample is a decision rule, and the decision rule is explanatory data. Because of this, in a case where three rules surrounded by a dotted-line frame are decision rules in a case where a training sample is given to the decision list depicted in FIG. 11, the explanation generating unit 15 generates, as explanatory data, the decision rules “(x₀≤1.0 OR X₂≥2.0) AND x₁≤2.0 AND x₂<3.0.”

Similarly to the first example embodiment mentioned above, the parameter calculating unit 12 in the present example embodiment computes a rule which is parameters of a prediction model that minimizes the objective function L including the prediction loss which is the difference between a prediction value and a ground truth value, and a weighted sum of the explanation loss which is the difference between explanatory data, which is a decided rule, and a ground truth rule. For example, the objective function L can be represented by the following Formula 31

$$L = {\sum }_{t ∈ T} {L}_{acc} ( f ( t ) , f b ( t ) ) + λ {L}_{exp} ( rule ( f , t ) , rule ( fb , t ) ) \qquad [ Formula 31 ]$$

It is assumed here that a rule set included in the model f is R={r₁, . . . , rₙ}. The training sample set is T={t₁, . . . , tₙ}. In addition, a prediction model being trained is f, and a prediction model before being trained is fb. It is assumed here that the prediction value (fb(t)) output by the prediction model fb before being trained is used as a ground truth value, and the rule (rule(fb,t)) output by the prediction model fb before being trained is used as a ground truth rule.

L_{ace} described above is the prediction loss representing a prediction error representing the difference between the prediction value f(t) and the ground truth value f(fb(t)). For example, the prediction loss L_{ace} can be represented by an error function such as a squared error. Lₑₓₚ described above is the explanation loss representing an error representing the difference between the rule rule(f,t) used at the time of prediction and the ground truth rule rule(fb,t). For example, an index like the one represented by Formula 32 can be used as Lₑₓₚ.

$${L}_{exp} ( {r}_{1} , {r}_{2} ) = \frac{\# ( samples satisfying conditions of {r}_{1} ) ⋂ ( samples satisfying conditions of {r}_{2} )}{\# ( samples satisfying conditions of {r}_{1} ) ⋃ ( samples satisfying conditions of {r}_{2} )} \qquad [ Formula 32 ]$$

Here, for example, calculation by the parameter calculating unit 12 can be performed by representing the objective function L described above as a linear programming problem representation of a loss function. That is, “L_{ace}+λLₑₓₚ” included in the objective function L is represented by a linear programming problem representation. The method for representing L_{ace} in “L_{ace}+λLₑₓₚ” differs depending on a prediction model, and the representation methods of a decision tree and a decision list are known. In addition, Lₑₓₚ can be represented as follows.

First, it is assumed that each element sᵢⱼ in a two-dimensional matrix S={Sᵢⱼ}_{i=1, . . . , m,j=1 . . . , n} is Lₑₓₚ(rⱼ,rule(f_{b},t)). That is, it is the explanation loss of a rule used by the model fb before being trained for prediction of a sample xᵢ and a rule rᵢ output during training. In addition, each element dᵢⱼ of a two-dimensional matrix D={dᵢⱼ}_{i=1, . . . , m,j=1 . . . , n} is 1 in a case where rᵢ is used for an explanation used for a prediction of a sample xₑ, and is 0 otherwise. Using what has been described above, Lₑₓₚ can be represented by Formula 33.

$${L}_{exp} = {\sum }_{i = 1}^{m} {\sum }_{j = 1}^{n} {S}_{ij} {d}_{ij} \qquad [ Formula 33 ]$$

Note that, in the present example embodiment also, ground truth explanations may be associated with only training samples that, when input to a machine learning model, make the machine learning model output prediction values matching ground truth labels. Thereby, for example, the objective function L may be represented by the following Formula 34. At this time, the second term is the prediction loss of a training sample for which a correct prediction has been output, and the third term is the explanation loss of a training sample for which a correct prediction has been output.

$$L = {\sum }_{t ∈ T} {L}_{acc} ( f ( t ) , fb ( t ) ) + {λ}_{1} {\sum }_{{t}^{′} ∈ {Tcorr}_{ect}} {L}_{acc} ( f ( t ) , fb ( t ) ) + {λ}_{2} {\sum }_{{t}^{′} ∈ {Tcorr}_{ect}} {L}_{exp} ( rule ( f , t ) , rule ( fb , t ) \qquad [ Formula 34 ]$$

### Third Example Embodiment

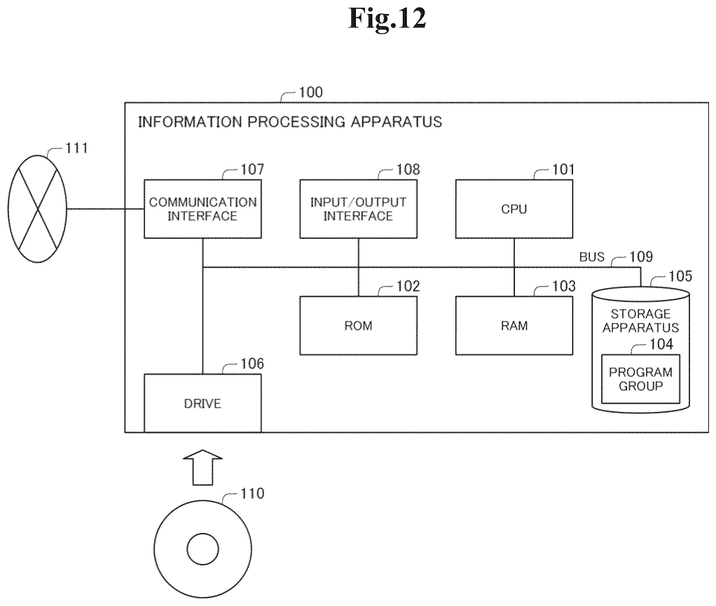

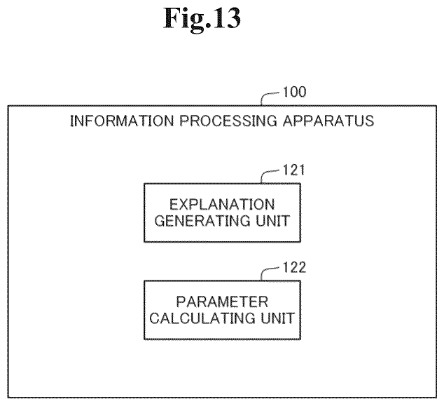

Next, a third example embodiment of the present disclosure is explained with reference to FIG. 12 to FIG. 13. FIG. 12 to FIG. 13 are block diagrams depicting the configuration of an information processing apparatus in the third example embodiment. Note that an outline of the configuration of the information processing apparatus explained in the example embodiments mentioned above is depicted in the present example embodiment.

First, the hardware configuration of an information processing apparatus 100 in the present example embodiment is explained with reference to FIG. 12. The information processing apparatus 100 is configured using a typical information processing apparatus, and has a hardware configuration as described below as an example.
Central Processing Unit (CPU) 101 (arithmetic apparatus)
Read Only Memory (ROM) 102 (storage apparatus)
Random Access Memory (RAM) 103 (storage apparatus)
Program group 104 to be loaded to RAM 103
Storage apparatus 105 having stored thereon the program group 104
Drive 106 that performs reading and writing on a storage medium 110 outside the information processing apparatus
Communication interface 107 connected to a communication network 111 outside the information processing apparatus
Input/output interface 108 for performing input/output of data
Bus 109 connecting the respective constituent elements

The information processing apparatus 100 can construct and be equipped with an explanation generating unit 121 and a parameter calculating unit 122 depicted in FIG. 13 through acquisition of the program group 104 and execution thereof by the CPU 101. Note that the program group 104 is stored on, for example, the storage apparatus 105 or the ROM 102 in advance, is loaded to the RAM 103 by the CPU 101, and is executed by the CPU 101 as needed. In addition, the program group 104 may be supplied to the CPU 101 via the communication network 111, or may be stored on the storage medium 110 in advance, read out by the drive 106, and supplied to the CPU 101. It should be noted that the explanation generating unit 121 and the parameter calculating unit 122 mentioned above may be constructed using electronic circuits dedicated for realizing the means.

Note that FIG. 12 depicts an example of the hardware configuration of the information processing apparatus that is the information processing apparatus 100. The hardware configuration of the information processing apparatus is not limited to that mentioned above. For example, the information processing apparatus may be configured using part of the configuration mentioned above, such as without the drive 106. In addition, instead of the CPU mentioned above, the information processing apparatus can use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, a combination of these, or the like.

The explanation generating unit 121 described above generates explanatory data explaining a prediction value output by the machine learning model as a response to an input of training data. As an example, the machine learning model is a model whose parameters can be updated using the gradient of an objective function, and can generate explanatory data on the basis of the importance of training data for a prediction value. In addition, as an example, the machine learning model is a model that predicts a prediction value using a plurality of rules, and can generate, as explanatory data, a rule to which training data is relevant in the machine learning model.

The parameter calculating unit 122 described above calculates parameters of the machine learning model so as to reduce the prediction loss representing the degree of difference between a preset ground truth value and a prediction value output by the machine learning model as a response to an input of the training data, and to reduce the explanation loss representing the degree of unsatisfaction, by the explanatory data, of a preset criterion that the explanatory data should satisfy. For example, the explanation loss is the difference between generated explanatory data and ground truth data in a case where the ground truth data for the explanatory data is given.

By being configured in the manners above, the present disclosure updates parameters of a machine learning model so as to reduce the prediction loss and the explanation loss, and thereby can reduce situations where explanations of prediction values output by the machine learning model are different for each sample.

Note that the programs mentioned above can be supplied to a computer by being stored using a non-transitory computer readable medium (non-transitory computer readable medium) of any type. Non-transitory computer readable media include tangible recording media (tangible storage media) of various types. Examples of non-transitory computer readable media include a magnetic recording medium (e.g. flexible disc, magnetic tape, hard disk drive), a magneto-optical recording medium (e.g. magneto-optical disc), a CD-ROM (Read Only Memory), a CD-R, a CD-R/W, and a semiconductor memory (e.g. mask ROM, PROM (Programmable ROM), EPROM (Erasable PROM), flash ROM, and RAM (Random Access Memory)). In addition, the programs may also be supplied to a computer by being stored on a transitory computer readable medium (transitory computer readable medium) of any type. Examples of transitory computer readable media include electric signals, optical signals, and electromagnetic waves. A transitory computer readable medium can supply programs to a computer via a wired communication channel such as an electric wire or an optical fiber, or a wireless communication channel.

While the present disclosure has been explained thus far with reference to the example embodiments and the like described above, the present disclosure is not limited to the example embodiments mentioned above. The configurations and details of the present disclosure can be changed within the scope of the present disclosure in various manners that can be understood by those skilled in the art. In addition, at least one or more functions of the functions of the explanation generating unit and the parameter calculating unit mentioned above may be executed at an information processing apparatus installed and connected at any location on a network, that is, may be executed by so-called cloud computing.

### SUPPLEMENTARY NOTES

Part of or the whole of the example embodiments described above can also be described as in the following supplementary notes. Hereinafter, an outline of the configurations of an information processing apparatus, an information processing method, and a program in the present disclosure are explained. It should be noted that the present disclosure is not limited to the following configurations.

### Supplementary Note 1

An information processing apparatus comprising:
an explanation generating unit that generates explanatory data explaining a prediction value output by a machine learning model as a response to an input of training data; and
a parameter calculating unit that calculates a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

### Supplementary Note 2

The information processing apparatus according to supplementary note 1, wherein the parameter calculating unit calculates a parameter of the machine learning model so as to reduce the prediction loss and the explanation loss representing a degree of difference between the explanatory data and preset ground truth explanatory data.

### Supplementary Note 3

The information processing apparatus according to supplementary note 1, wherein the parameter calculating unit calculates a parameter of the machine learning model so as to reduce the prediction loss and the explanation loss based on a weighted sum of the explanatory data including a plurality of elements.

### Supplementary Note 4

The information processing apparatus according to supplementary note 1, wherein the explanation generating unit generates the explanatory data on a basis of an importance of each of elements included in the training data for a prediction value output by the machine learning model.

### Supplementary Note 5

The information processing apparatus according to supplementary note 4, wherein
the explanation generating unit generates the explanatory data using, as the importance, a differentiable function using the machine learning model, and
the parameter calculating unit calculates a parameter of the machine learning model by calculating a gradient of the explanation loss using differentiation of the function.

### Supplementary Note 6

The information processing apparatus according to supplementary note 5, wherein the explanation generating unit generates the explanatory data using, as the function, a parameter of a second machine learning model based on the machine learning model in a case where the second machine learning model is trained using second training data generated based on the training data.

### Supplementary Note 7

The information processing apparatus according to supplementary note 1, wherein
the machine learning model is a model that predicts a prediction value using a plurality of rules,
the explanation generating unit generates, as the explanatory data, a rule to which the training data is relevant in the machine learning model, and
the parameter calculating unit calculates a parameter of the machine learning model so as to reduce the prediction loss and the explanation loss representing a degree of difference between the explanatory data and a preset ground truth rule.

### Supplementary Note 8

The information processing apparatus according to supplementary note 2, wherein
the information processing apparatus comprises a ground truth explanation giving unit that associates the ground truth explanatory data with the training data, and
the ground truth explanation giving unit acquires the training data, a ground truth label corresponding to the training data, and an initial parameter of the machine learning model, and associates, with the training data as the ground truth explanatory data, the explanatory data generated when the training data is input to the machine learning model using the initial parameter as a parameter of the machine learning model.

### Supplementary Note 9

The information processing apparatus according to supplementary note 8, wherein the ground truth explanation giving unit associates the ground truth explanatory data only with the training data that, when input to the machine learning model, makes the machine learning model output the prediction value matching the ground truth value.

### Supplementary Note 10

An information processing method comprising:
generating explanatory data explaining a prediction value output by a machine learning model as a response to an input of training data; and
calculating a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

### Supplementary Note 11

A computer readable storage medium having stored thereon a program for causing a computer to execute processes of:
generating explanatory data explaining a prediction value output by a machine learning model as a response to an input of training data; and
calculating a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

### REFERENCE SIGNS LIST

information processing apparatus
11 input unit
12 parameter calculating unit
13 prediction loss calculating unit
14 explanation loss calculating unit
15 explanation generating unit
20 ground truth explanation giving unit
100 information processing apparatus
101 CPU
102 ROM
103 RAM
104 program group
105 storage apparatus
106 drive
107 communication interface
108 input/output interface
109 bus
110 storage medium
111 communication network
121 explanation generating unit
122 parameter calculating unit

What is claimed is:

1. An information processing apparatus comprising:
at least one memory configured to store instructions; and
at least one processor configured to execute instructions to:
generate explanatory data explaining a prediction value output by a machine learning model as a response to an input of training data; and
calculate a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

2. The information processing apparatus according to claim 1, wherein the at least one processor is configured to execute the instructions to calculate a parameter of the machine learning model so as to reduce the prediction loss and the explanation loss representing a degree of difference between the explanatory data and preset ground truth explanatory data.

3. The information processing apparatus according to claim 1, wherein the at least one processor is configured to execute the instructions to calculate a parameter of the machine learning model so as to reduce the prediction loss and the explanation loss based on a weighted sum of the explanatory data including a plurality of elements.

4. The information processing apparatus according to claim 1, wherein generate the at least one processor is configured to execute the instructions to the explanatory data on a basis of an importance of each of elements included in the training data for a prediction value output by the machine learning model.

5. The information processing apparatus according to claim 4, wherein
the at least one processor is configured to execute the instructions to:
generate the explanatory data using, as the importance, a differentiable function using the machine learning model, and
calculate a parameter of the machine learning model by calculating a gradient of the explanation loss using differentiation of the function.

6. The information processing apparatus according to claim 5, wherein the at least one processor is configured to execute the instructions to generate the explanatory data using, as the function, a parameter of a second machine learning model based on the machine learning model in a case where the second machine learning model is trained using second training data generated based on the training data.

7. The information processing apparatus according to claim 1, wherein
the machine learning model is a model that predicts a prediction value using a plurality of rules,
the at least one processor is configured to execute the instructions to:
generate, as the explanatory data, a rule to which the training data is relevant in the machine learning model, and
calculate a parameter of the machine learning model so as to reduce the prediction loss and the explanation loss representing a degree of difference between the explanatory data and a preset ground truth rule.

8. The information processing apparatus according to claim 2, wherein
the at least one processor is configured to execute the instructions to, when the ground truth explanatory data is associated with the training data,
acquire the training data, a ground truth label corresponding to the training data, and an initial parameter of the machine learning model, and associate, with the training data as the ground truth explanatory data, the explanatory data generated when the training data is input to the machine learning model using the initial parameter as a parameter of the machine learning model.

9. The information processing apparatus according to claim 8, wherein the at least one processor is configured to execute the instructions to associate the ground truth explanatory data only with the training data that, when input to the machine learning model, makes the machine learning model output the prediction value matching the ground truth value.

10. An information processing method comprising:
generating explanatory data explaining a prediction value output by a machine learning model as a response to an input of training data; and
calculating a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.

11. A non-transitory computer readable storage medium having stored thereon a program comprising instructions for causing a computer to execute processes of:
generating explanatory data explaining a prediction value output by a machine learning model as a response to an input of training data; and
calculating a parameter of the machine learning model so as to reduce a prediction loss representing a degree of difference between a preset ground truth value and a prediction value output by the machine learning model as a response to the input of the training data, and to reduce an explanation loss representing a degree of unsatisfaction, by the explanatory data, of a preset criterion that the explanatory data should satisfy.
